(19) United States
(12) Patent Application Publication
(10) Pub. No.: US 2010/0073905 A1
(43) Pub. Date: Mar. 25, 2010

(54) Structure of advertising box having modular lighting device and structure of same modular lighting device

(75) Inventor: Lee Hsin-Nung, Sijhih City (TW)

Correspondence Address: Juan Carlos A. Marquez;c/o Stites & Harbison PLLC, 1199 North Fairfax Street, Suite 900, Alexandria, VA, 22314-1437, US

(73) Assignee: Sinology Enterprise Ltd.

(21) Appl. No.: 12/292,658

(22) Filed: Nov. 24, 2008

(30) Foreign Application Priority Data
Sep. 22, 2008 (TW) 097136332

(51) Int. Cl. G09F 13/08; F21V 8/00; F21K 7/00; F21V 33/00

(52) U.S. Cl. 362/97.1; 362/311.01; 362/235; 362/84

(57) ABSTRACT

Disclosed are a structure of an advertising box having modular lighting devices and a structure of the modular lighting device. The structure of the advertising box includes a box and plural modular lighting devices fixedly installed inside a frame of the box. The modular lighting device has a housing, a light guide plate, a lighting unit and plural electrical connectors. The light guide plate is coupled with the housing while the lighting unit is optically coupled with a light incident surface of the light guide plate. At least one lateral side of the housing is provided with the electrical connectors, so that the lighting units in the modular lighting devices are electrically coupled with each other through the electrical connectors. The modular lighting devices enable replacement of lighting devices of uniform sizes and can form light sources of various sizes for use with different kinds of advertising boxes.

### BACKGROUND OF THE INVENTION

1. Technical Field

The present invention relates to a structure of a light box having modular lighting devices and a structure of the modular lighting device. More particularly, the present invention relates to a structure of an advertising box having modular lighting devices and a structure of the modular lighting device.

2. Description of Related Art

Generally, a light box for advertising purposes has a structure comprising a light-transmitting box and a lighting device. These light boxes are made into various sizes depending on their intended use in, among others, publicity campaigns, exhibitions and advertisement. However, as the dimensions of the light boxes vary, backlights used therein must also be available in a variety of sizes, which inevitably increases the costs of material inventory control, packaging, storage and transportation.

Taiwan Patent No. M289892 discloses “Modular Advertising Box and Combinations Thereof”, comprising a plurality of modular advertising boxes and a control unit. Therein, each of the modular advertising boxes is provided with a lighting device, an input end and an output end. The input ends and the output ends allow adjacent modular advertising boxes to be coupled with one another. Meanwhile, the control unit is configured to control variation of lighting conditions of the lighting devices in the modular advertising boxes.

According to the Taiwan Patent cited above, the modular advertising boxes are coupled with one another via the input ends and the output ends. Consequently, the number of the modular advertising boxes to be used can be selected to suit specific needs. However, the advertising boxes are often required to have their shapes modified to cope with different applications. Therefore, if advertising boxes of irregular shapes are desired and cannot be realized by combinations of the modular advertising boxes, new advertising boxes and lighting devices used therein must be made to the intended specifications. As such, the modular advertising boxes, which are incapable of forming arbitrary shapes, have a limited scope of applications.

In addition, U.S. Pat. No. 7,350,937 B2 teaches “Lighting Unit, Lighting Module and Liquid Crystal Display”, wherein a backlight module comprises a plurality of direct-lit backlight units coupled with one another by electrical connectors. However, the direct-lit backlight units have invariable light-emitting directions, thereby preventing uniform light emission in all directions. Furthermore, as each direct-lit backlight unit requires a large number of light-emitting diodes, high production costs and heat dissipation problems ensue.

### BRIEF SUMMARY OF THE INVENTION

An objective of the present invention is to provide a structure of an advertising box having modular lighting devices and a structure of the modular lighting device, wherein each of the modular lighting devices in the structure of the advertising box is provided with at least one electrical connector to enable formation of light sources of various sizes as needed.

Another objective of the present invention is to provide a structure of an advertising box having modular lighting devices and a structure of the modular lighting device, wherein the modular lighting devices can be combined into different shapes so as to reduce the cost of making light sources of special dimensions.

Still another objective of the present invention is to provide a structure of an advertising box having modular lighting devices and a structure of the modular lighting device, wherein the structure of the modular lighting device comprises a light source that emits light in a lateral direction so as to achieve uniform light emission in all direction.

To attain these objectives, the present invention provides a structure of an advertising box having modular lighting devices, wherein the structure of the advertising box comprises a box including a frame and a light-transmitting plate, and a plurality of modular lighting devices fixedly installed on a lower surface inside the frame. Each of the modular lighting devices comprises a housing; a light guide plate coupled with the housing and having at least one light-emitting surface and at least one light incident surface, wherein the light-emitting surface is disposed on one side of the light-transmitting plate and optically coupled with the light-transmitting plate; a lighting unit optically coupled with the light incident surface; and a plurality of electrical connectors provided on at least one lateral side of the housing and electrically coupled with the lighting unit, so that the modular lighting devices are electrically coupled with each other by the electrical connectors.

To attain the aforementioned objectives, the present invention further provides a structure of a modular lighting device comprising a housing; a light guide plate coupled with the housing and having at least one light-emitting surface and at least one light incident surface; a lighting unit optically coupled with the light incident surface; and a plurality of electrical connectors provided on at least one lateral side of the housing and electrically coupled with the lighting unit.

The present invention can be implemented to provide at least the following advantageous effects:

1. The modular lighting devices can be combined as needed to suit advertising boxes of special dimensions, thereby cutting the cost of making new modular lighting devices and lowering the inventory level of the modular lighting devices.

2. The structure of the advertising box is capable of more applications as the modular lighting devices can be combined to form light sources of arbitrary dimensions.

3. The structure of the modular lighting device emits light in a lateral direction so as to reduce the number of light-emitting diodes required. Thus, the modular lighting device not only has its cost reduced but also dissipates heat more easily.

A detailed description of further features and advantages of the present invention is given below, so that a person skilled in the art is enabled to understand and implement the technical contents of the present invention and readily comprehend the objectives and advantages thereof by reviewing the teachings disclosed herein, the appended claims and the accompanying drawings.

### BRIEF DESCRIPTION OF THE SEVERAL VIEWS OF THE DRAWINGS

The invention as well as a preferred mode of use, further objectives and advantages thereof will be best understood by referring to the following detailed description of illustrative embodiments in conjunction with the accompanying drawings, wherein:

FIG. 1 is an exploded perspective view of a structure of an advertising box having modular lighting devices according to the present invention;

FIG. 2 shows the advertising box of FIG. 1 in an assembled state;

FIG. 3A is a sectional view of the advertising box taken along a line A-A in FIG. 2;

FIG. 3B is a partial enlarged view of the advertising box in FIG. 3A;

FIG. 4 is an exploded perspective view of a structure of a modular lighting according to the present invention;

FIG. 5A is a sectional view of the modular lighting taken along a line B-B in FIG. 4;

FIG. 5B is a sectional view of a modular lighting according to another embodiment of the present invention taken along the line B-B in FIG. 4;

FIG. 6 illustrates connection between the modular lighting devices of the present invention; and

FIG. 7 illustrates an application of the modular lighting devices of the present invention.

### DETAILED DESCRIPTION OF THE INVENTION

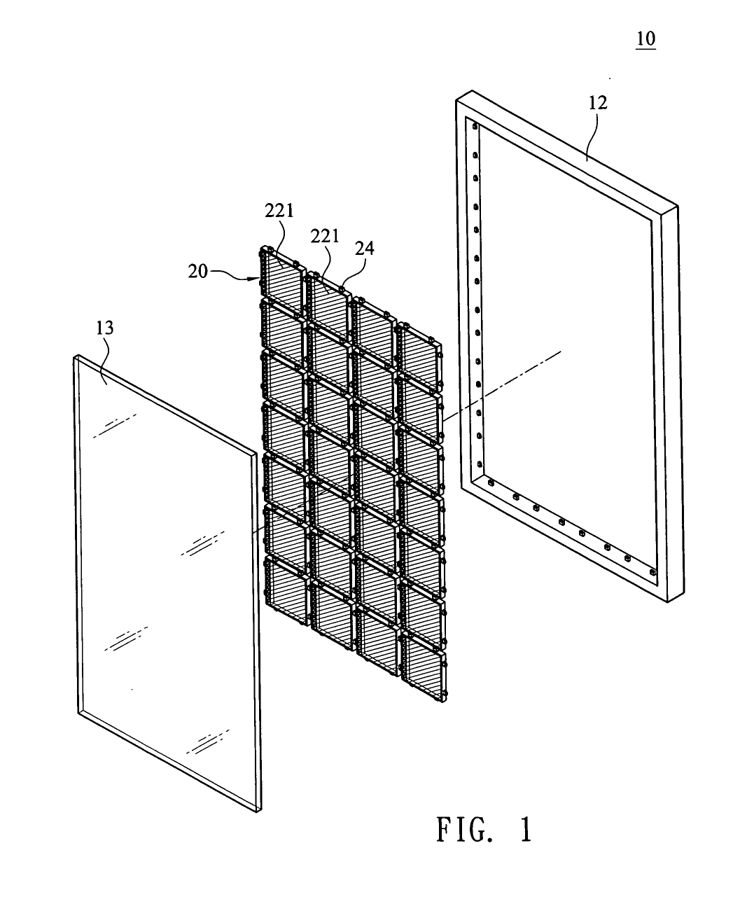

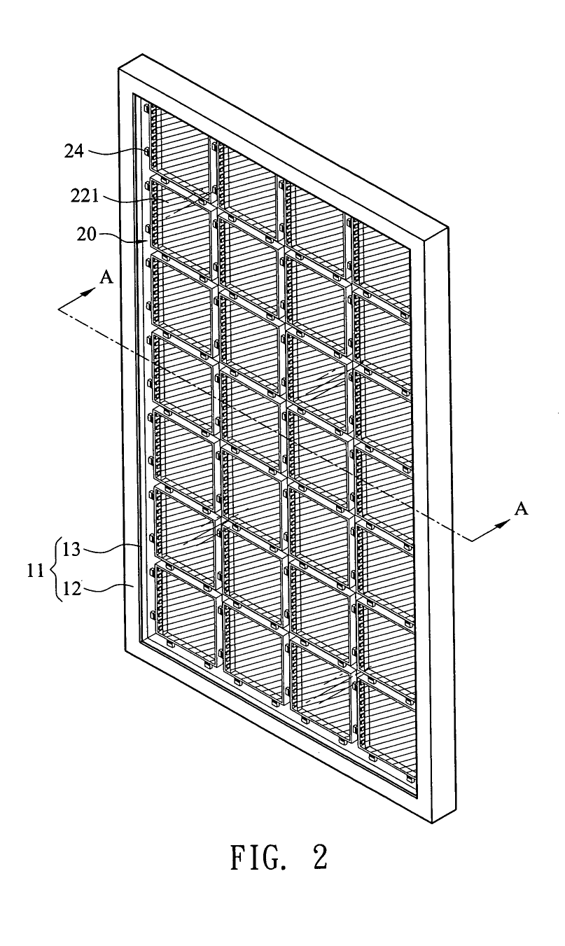

Referring to FIGS. 1 and 2, a structure 10 of an advertising box having modular lighting devices according to an embodiment of the present invention comprises a box 11 and a plurality of modular lighting devices 20.

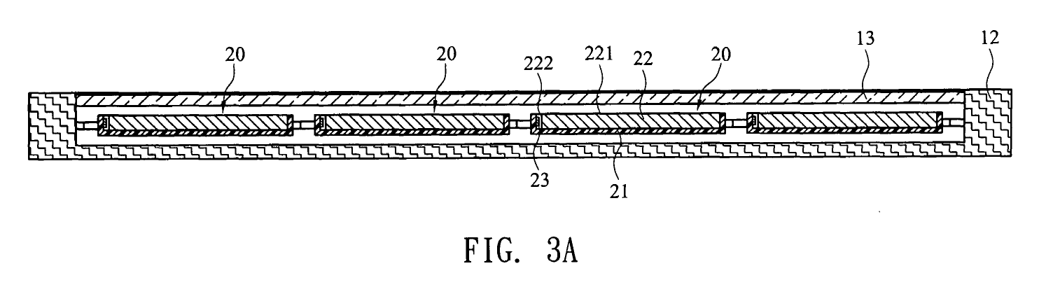

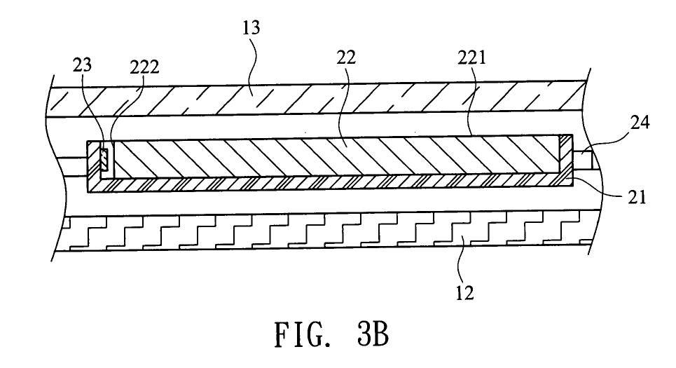

The box 11 is composed of a frame 12 and a light-transmitting plate 13. The light-transmitting plate 13, when coupled with the frame 12, is connected tightly therewith, as shown in FIG. 3A, to form an enclosed receiving space substantially impermeable to moisture.

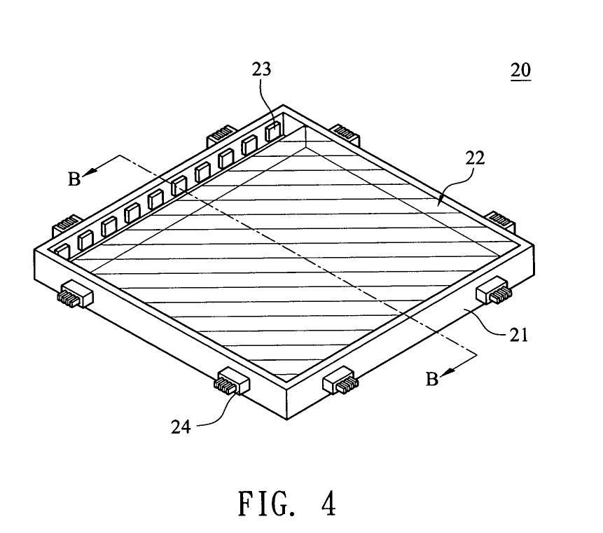

Referring to FIG. 3A, the modular lighting devices 20 are fixedly installed inside the frame 12 of the box 11. As can be seen clearly in FIG. 4, each of the modular lighting devices 20 comprises a housing 21, a light guide plate 22, a lighting unit 23 and at least one electrical connector 24.

The housing 21, which can be a plastic housing, has a thickness smaller than about 1 cm, thereby allowing each of the modular lighting device 20 to have a very thin structure.

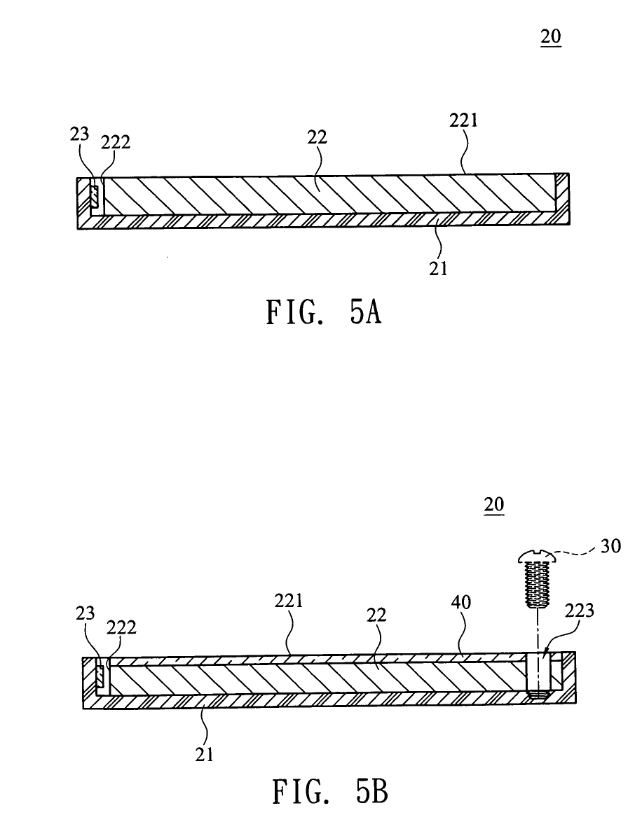

As shown in FIG. 5A, the light guide plate 22 is coupled with the housing 21 and has at least one light-emitting surface 221 and at least one light incident surface 222. Furthermore, the light guide plate 22 can be connected with the housing 21 by ultrasonic welding.

Besides, as shown in FIG. 5B, the light guide plate 22 may have an end portion formed with a fastening hole 223, which can be connected with a threaded element 30 so as to fasten the light guide plate 22 to the housing 21. Apart from that, the light-emitting surface 221 of the light guide plate 22 may be further provided with a phosphor layer 40 for modulating the color of emitted light. Referring now to FIG. 3B, the light-emitting surface 221 of the light guide plate 22 is disposed on one side of the light-transmitting plate 13 of the box 11 and optically coupled with the light-transmitting plate 13, so that light reflected from the light guide plate 22 will be projected completely toward the light-transmitting plate 13. Uniform light emission can be achieved by altering a structure of the light guide plate 22, such as by forming grooves or protrusions thereon, so as to control light-emitting angles of the modular lighting devices 20.

As shown in FIGS. 5A and 5B, the lighting unit 23 is optically coupled with the light incident surface 222 of the light guide plate 22 and may comprise a plurality of light-emitting diodes. Light emitted from the lighting unit 23 is optically coupled into the light guide plate 22 through the light incident surface 222, and then reflected by the light-emitting surface 221 of the light guide plate 22, thus serving as a light source for the structure 10 of the advertising box having modular lighting devices.

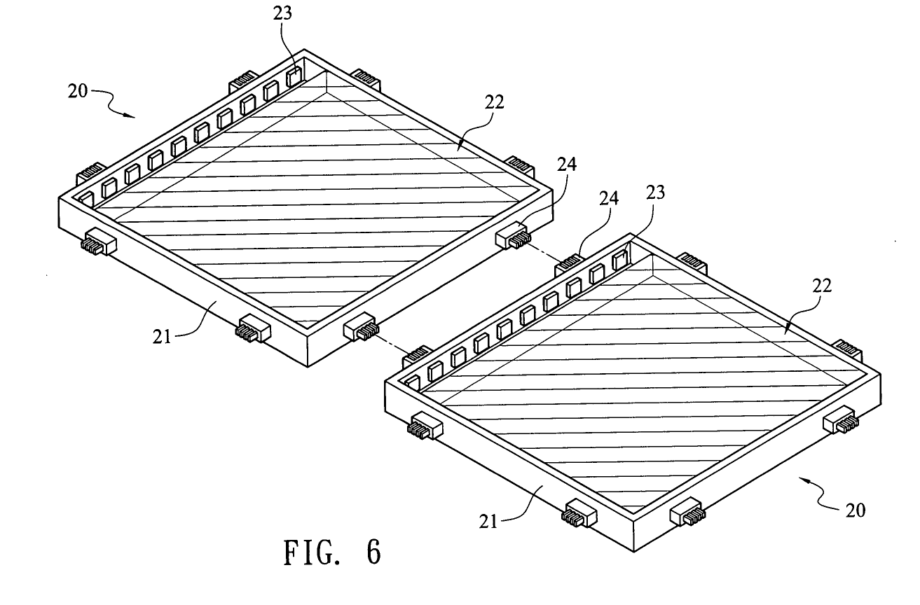

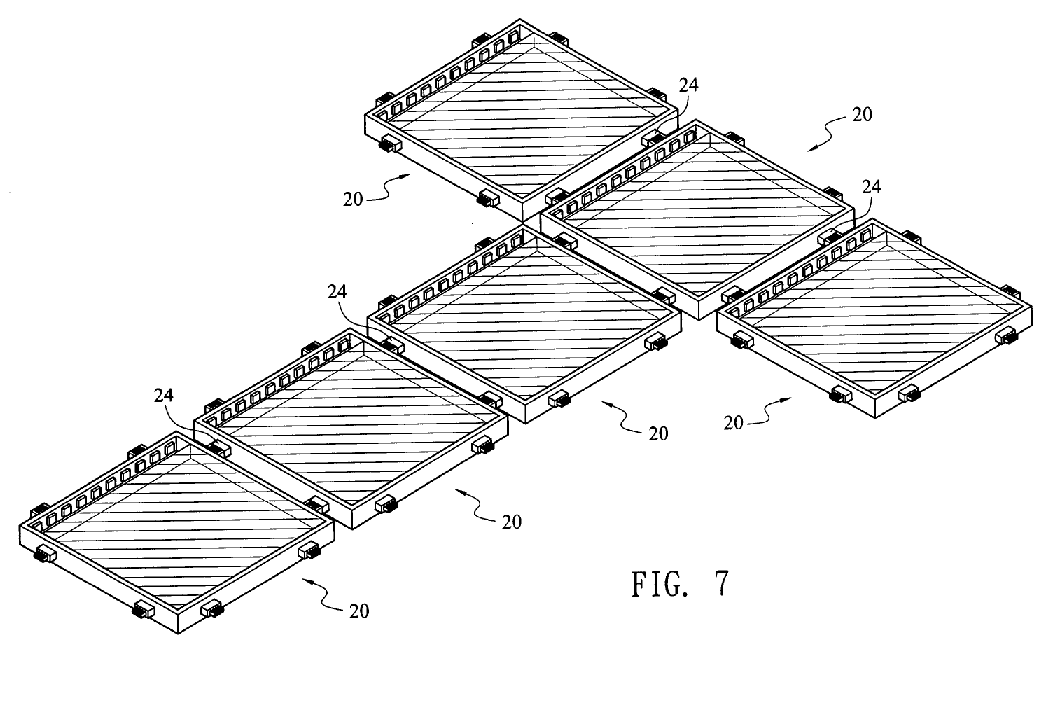

Referring to FIG. 4, at least one lateral side of the housing 21 is provided with the electrical connector 24 wherein the electrical connector 24 is electrically coupled with the lighting unit 23 so that when the electrical connectors 24 of two adjacent said modular lighting devices 20 are connected, the two modular lighting devices 20 are electrically and coplanarly coupled with each other, as shown in FIG. 6.

The modular lighting devices 20 may have such dimension as 30×30 cm, 15×15 cm or 1×1 ft, but not limited thereto. By using modular lighting devices 20 of different dimensions, light sources of various sizes can be formed with the assistance of the electrical connectors 24. As shown in FIG. 7, the modular lighting devices 20, each having a small size, can be combined to form arbitrary shapes, before being coupled with the box 11 to complete the structure 10 of the advertising box having modular lighting devices, thereby broadening the applications of the modular lighting devices 20.

The present invention also provides a structure 20 of a modular lighting device comprising a housing 21, a light guide plate 22, a lighting unit 23 and at least one electrical connector 24. The at least one electrical connector 24 allows the structure 20 of the modular lighting device to be electrically coupled with another such structure 20, thereby forming light sources of various sizes. Hence, the structure 20 of the modular lighting device has a broader scope of applications than that of conventional lighting devices having uniform sizes.

The present invention has been described with reference to preferred embodiments thereof to enable a person skilled in the art to understand and implement the contents of the present invention. These embodiments, however, are not intended to limit the scope of the present invention. Therefore, all equivalent changes or modifications which do not depart from the spirit of the present invention should be encompassed by the appended claims.

1. A structure of an advertising box having modular lighting devices, comprising:
box comprising a frame and a light-transmitting plate; and
plurality of modular lighting devices fixedly installed inside the frame, each said modular lighting device comprising:
housing;
light guide plate coupled with the housing and having at least one light-emitting surface and at least one light incident surface, wherein the light-emitting surface is disposed on one side of the light-transmitting plate and optically coupled with the light-transmitting plate;
lighting unit optically coupled with the light incident surface; and
least one electrical connector provided on at least one lateral side of the housing and electrically coupled with the lighting unit;
wherein the modular lighting devices are electrically coupled with each other by the electrical connectors of the modular lighting devices.

2. The structure of the advertising box as claimed in claim 1, wherein the light guide plate has an end portion formed with a fastening hole.

3. The structure of the advertising box as claimed in claim 1, wherein the light-emitting surface of the light guide plate is provided with a phosphor layer.

4. The structure of the advertising box as claimed in claim 1, wherein the lighting unit comprises a plurality of light-emitting diodes.

5. The structure of the advertising box as claimed in claim 1, wherein each said modular lighting device has dimensions of 30×30 cm.

6. The structure of the advertising box as claimed in claim 1, wherein each said modular lighting device has dimensions of 15×15 cm.

7. The structure of the advertising box as claimed in claim 1, wherein each said modular lighting device has dimensions of 1×1 ft.

8. The structure of the advertising box as claimed in claim 1, wherein each said modular lighting device is coupled coplanarly with an adjacent said modular lighting device.

9. A structure of a modular lighting device, comprising:
a housing;
a light guide plate coupled with the housing and having at least one light-emitting surface and at least one light incident surface;
a lighting unit optically coupled with the light incident surface; and
at least one electrical connector provided on at least one lateral side of the housing and electrically coupled with the lighting unit.

10. The structure of the modular lighting device as claimed in claim 9, wherein the light guide plate has an end portion formed with a fastening hole.

11. The structure of the modular lighting device as claimed in claim 9, wherein the lighting unit comprises a plurality of light-emitting diodes.

12. The structure of the modular lighting device as claimed in claim 9, wherein the light-emitting surface of the light guide plate is provided with a phosphor layer.

13. The structure of the modular lighting device as claimed in claim 9, wherein the modular lighting device has dimensions of 30×30 cm.

14. The structure of the modular lighting device as claimed in claim 9, wherein the modular lighting device has dimensions of 15×15 cm.

15. The structure of the modular lighting device as claimed in claim 9, wherein the modular lighting device has dimensions of 1×1 ft.
